(19) United States
(12) Patent Application Publication
(10) Pub. No.: US 2007/0212145 A1
(43) Pub. Date: Sep. 13, 2007

(54) System and method for detecting peripheral device

(75) Inventors: Ping-Hsien Chu, Tao Yuan Shien (TW); En-Hsien Lin, Tao Yuan Shien (TW)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Quanta Computer Inc.

(21) Appl. No.: 11/482,483

(22) Filed: Jul. 6, 2006

(30) Foreign Application Priority Data
Mar. 8, 2006 (TW) 095107694

(51) Int. Cl. B41J 29/38

(52) U.S. Cl. 400/76

(57) ABSTRACT

The invention discloses a system for detecting a peripheral device being installed onto an electronic apparatus. The peripheral device includes a cable, and the cable has M first pins, wherein a first detection pin is selected from the M first pins. The system includes a port and a delay circuit. The port has M second pins, and each second pin is corresponding to one of the first pins of the cable, wherein a grounded second detection pin is selected from the second pins, and the second detection pin generates a voltage signal in response to the first detection pin. The delay circuit is used for receiving the voltage signal and, after a predetermined delay time, for outputting a delayed voltage signal to the electronic apparatus. Accordingly, after receiving the delayed voltage signal, the electronic apparatus starts to detect the peripheral device.

### BACKGROUND OF THE INVENTION

1. Field of the Invention

The present invention relates to a system and a method thereof for detecting a peripheral device, and more particularly to a system and a method thereof for detecting a peripheral device normally when the peripheral device is installed onto a docking station of an electronic apparatus.

2. Description of the Prior Art

Referring to FIG. 1A, FIG. 1A is a perspective view illustrating the docking station 1 and the notebook 2 of the prior art. In general, though the notebook 2 has the convenience of being portable, the functions thereof are less than a desktop. Consequently, the docking station 1 has been developed to provide the notebook 2 with lots of ports, so as to install additional peripheral device, such as printer, scanner, and so on.

Referring to FIG. 1B, FIG. 1B is a schematic diagram illustrating the circuit between the docking station 1 and the notebook 2. For example, when a user wants to use a printer via the notebook, s/he has to connect the cable of the printer to the print port of the docking station, and then s/he can print something by the notebook once the notebook detects the printer. As shown in FIG. 1B, the print port 10 of the conventional docking station 1 has 25 pins (P₁-P₂₅), wherein the 18^{th} to 25^{th} pins (P₁₈-P₂₅) are grounded, and the 19^{th} pin (P₁₉) is used for detecting whether the cable of the printer has been inserted into the print port. The cable of the conventional printer (not shown) also has 25 pins, and each pin of the cable corresponds to one of the 25 pins (P₁-P₂₅) of the print port 10. Once the 19^{th} pin of the cable of the printer is connected to the 19^{th} pin (P₁₉) of the print port 10, the print port 10 will output a detection signal to notify the notebook 2 to detect the printer.

However, when the 19^{th} pin of the cable of the printer is connected to the 19^{th} pin (P₁₉) of the print port 10, the other pins of the cable of the printer may not be completely in contact with the other pins of the print port 10 yet, such that the notebook 2 does not detect the printer, and an error will occur accordingly.

Therefore, the present invention is to provide a system and a method thereof for detecting a peripheral device, so as to solve the aforementioned problems.

### SUMMARY OF THE INVENTION

The present invention is to provide a system and a method thereof for detecting a peripheral device. The system utilizes a delay circuit to delay a voltage signal and then output the delayed voltage signal to an electronic apparatus after a predetermined delay time, so as to trigger the electronic apparatus to detect the peripheral device. Accordingly, when the electronic apparatus receives the delayed voltage signal and starts to detect the peripheral device, each pin of the cable of the peripheral device is completely in contact with each corresponding pin of the port, such that the electronic apparatus can always detect the peripheral device.

According to a preferred embodiment, the system of the invention is used to detect a peripheral device installed to an electronic apparatus. The peripheral device comprises a cable, and the cable has M first pins, wherein a first detection pin is selected from the M first pins, and M is a natural number. The system comprises a port and a delay circuit. The delay circuit is coupled to the port.

In the aforesaid embodiment, the port has M second pins, each of which corresponds to one of the M first pins of the cable, wherein N second pins of the M second pins are grounded; a second detection pin, which generates a voltage signal in response to the first detection pin, is selected from the N second pins, and N is a natural number. The delay circuit is used for receiving the voltage signal and, after a predetermined delay time, for outputting a delayed voltage signal to the electronic apparatus, whereby the electronic apparatus starts to detect the peripheral device after receiving the delayed voltage signal.

Therefore, according to the system of the invention, the delay circuit delays the voltage signal and then outputs the delayed voltage signal to the electronic apparatus after a predetermined delay time, so as to trigger the electronic apparatus to detect the peripheral device. Afterward, when the electronic apparatus receives the delayed voltage signal and starts to detect the peripheral device, each pin of the cable of the peripheral device is completely in contact with each corresponding pin of the port, such that the electronic apparatus can always detect the peripheral device.

The advantage and spirit of the invention may be understood by the following recitations together with the appended drawings.

### BRIEF DESCRIPTION OF THE APPENDED DRAWINGS

FIG. 1A is a perspective view illustrating the docking station and the notebook of the prior art.

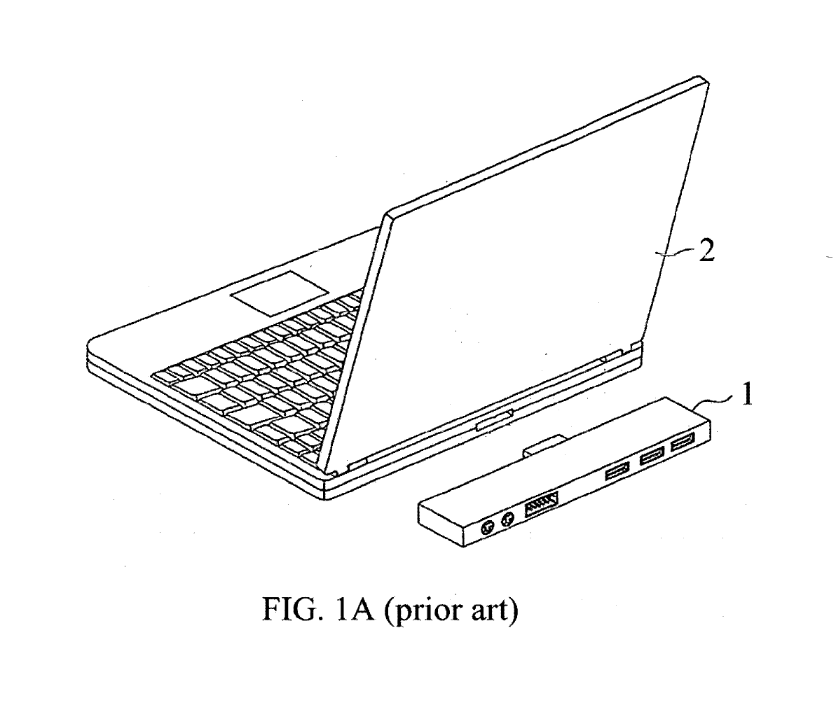

FIG. 1B is a schematic diagram illustrating the circuit between the docking station and the notebook.

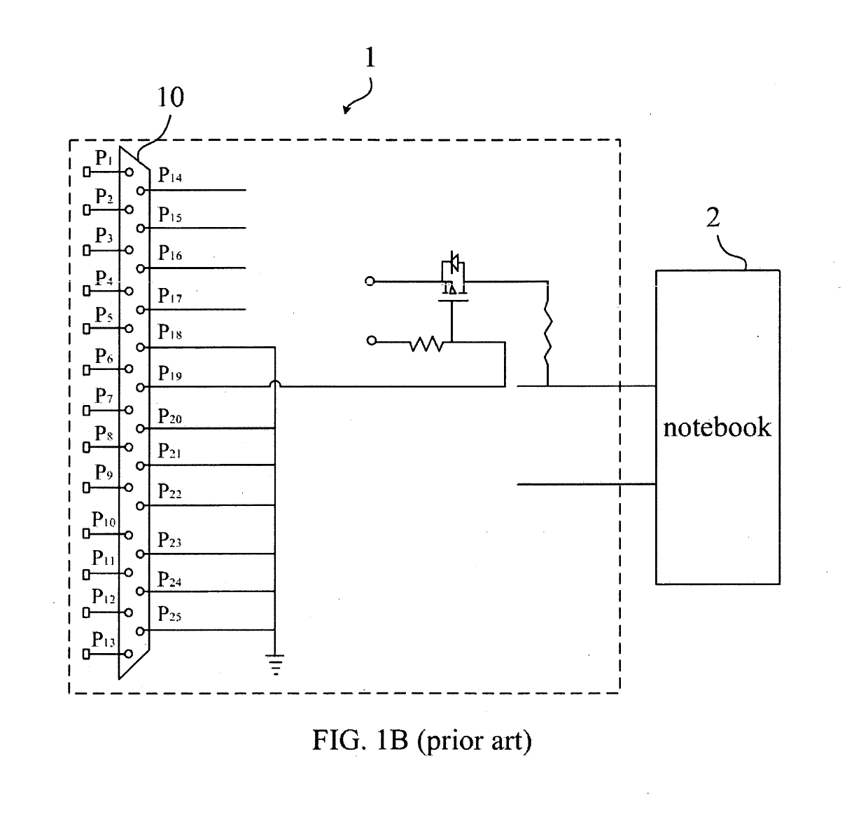

FIG. 2 is a schematic diagram illustrating the circuit between the system and the electronic apparatus according to a preferred embodiment of the invention.

FIG. 3 is a flowchart showing the method of the invention according to a preferred embodiment.

### DETAILED DESCRIPTION OF THE INVENTION

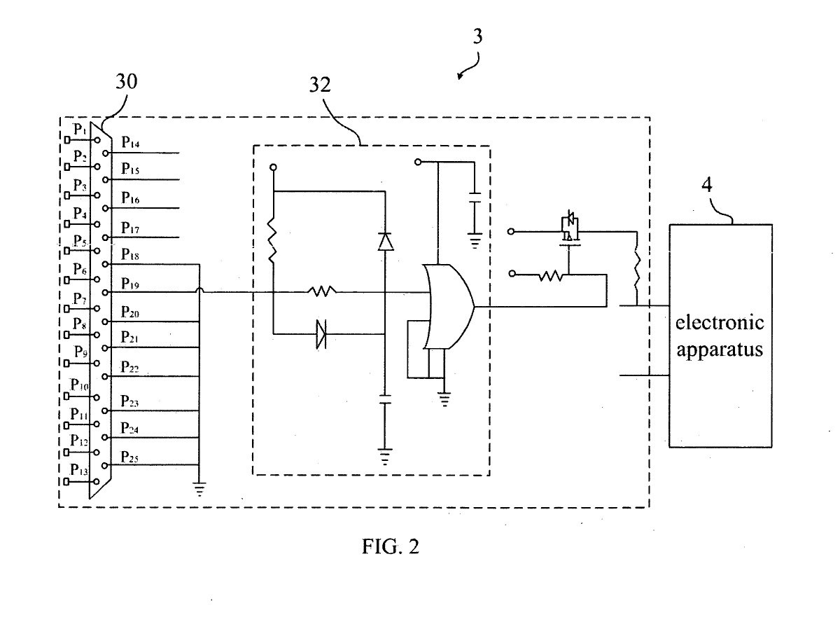

Referring to FIG. 2, FIG. 2 is a schematic diagram illustrating the circuit between the system 3 and the electronic apparatus 4 according to a preferred embodiment of the invention. The system 3 of the invention is used for detecting the peripheral device (not shown), such as a printer, a scanner, and so on, installed to the electronic apparatus 4. In this embodiment, the system 3 can be applied to a docking station (not shown), and the docking station is used to provide a port for the electronic apparatus 4 to install additional peripheral device. In this embodiment, the electronic apparatus 4 can be a notebook, and the peripheral device can be a printer. The printer comprises a cable, and the cable has 25 first pins, wherein a first detection pin is selected from the 25 first pins.

As shown in FIG. 2, the system 3 comprises a port 30 and a delay circuit 32 coupled to the port 30. The port 30 has 25 second pins (P₁-P₂₅), each of which corresponds to one of the 25 first pins of the cable of the printer. Eight of the second pins (P₁₈-P₂₅) of the 25 second pins (P₁-P₂₅) are grounded, and the second detection pin (P₁₉) generates a voltage signal in response to the first detection pin (the 19^{th} pin of the cable of the printer), wherein the voltage signal is a low voltage. The delay circuit 32 is used for receiving the voltage signal and, after a predetermined delay time, for outputting a delayed voltage signal to the electronic apparatus 4, whereby the electronic apparatus 4 starts to detect the peripheral device after receiving the delayed voltage signal.

It is preferred that the predetermined delay time can be set as 0.82 second. After receiving the delayed voltage signal, the electronic apparatus 4 will start to detect the printer after 0.226 second (process time of OS). Accordingly, when the first detection pin of the cable of the printer contacts the second detection pin (P19) of the port 30, the electronic apparatus 4 will start to detect the printer after 1 second or so (0.82+0.226=1.046 seconds).

Furthermore, in practical experience, after the first detection pin of the cable of the printer contacts the second detection pin (P₁₉) of the port 30, the user needs 0.3-0.8 second to make sure each pin of the cable of the printer contact each corresponding pin of the port 30 completely. In other words, after the first detection pin of the cable of the printer contacts the second detection pin P₁₉ of the port 30, there is one second or so for the user to make sure each pin of the cable of the printer contact each corresponding pin of the port 30. Consequently, once the printer is installed onto the docking station of the electronic apparatus 4, the electronic apparatus 4 can always detect the printer.

It should be noted that the delay circuit 32 can be designed based on different applications, so as to obtain different predetermined delay time.

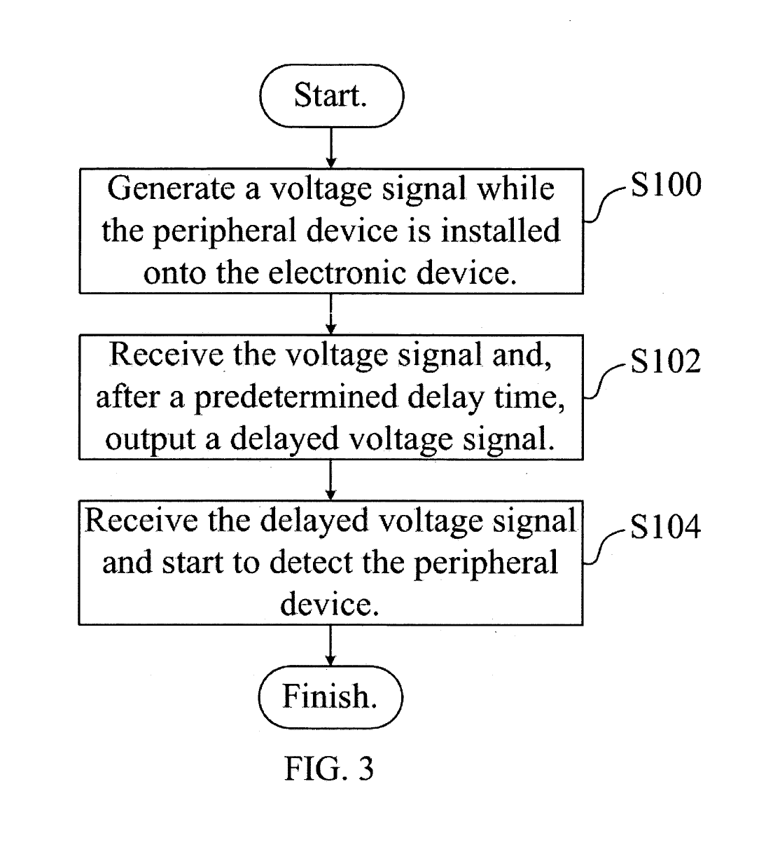

Referring to FIG. 3, FIG. 3 is a flowchart showing the method of the invention according to a preferred embodiment. Referring to FIG. 2 along with FIG. 3, the method of the invention is used for detecting a peripheral device installed onto the electronic apparatus 4. The method of the invention comprises the steps listed below. At the start, step S100 is performed to generate a voltage signal while the peripheral device is installed onto the electronic device. Afterward, step S102 is performed to receive the voltage signal and, after a predetermined delay time, to output a delayed voltage signal. Step S104 is then performed to receive the delayed voltage signal and to start to detect the peripheral device.

Compared to the prior art, according to the system of the invention and the method thereof, the delay circuit delays the voltage signal and then outputs the delayed voltage signal to the electronic apparatus after a predetermined delay time, so as to trigger the electronic apparatus to detect the peripheral device. Afterward, when the electronic apparatus receives the delayed voltage signal and starts to detect the peripheral device, each pin of the cable of the peripheral device has contacted each corresponding pin of the port completely, such that the electronic apparatus can always detect the peripheral device.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A system for detecting a peripheral device being installed onto an electronic apparatus, the peripheral device comprising a cable, the cable having M first pins, a first detection pin being selected from the M first pins, M being a natural number, the system comprising:
a port having M second pins, each of which corresponding to one of the M first pins of the cable, N second pins of the M second pins being grounded, a second detection pin being one selected from the N second pins, the second detection pin generating a voltage signal in response to the first detection pin, N being a natural number; and
a delay circuit coupled to the port, the delay circuit being used for receiving the voltage signal and, after a predetermined delay time, outputting a delayed voltage signal to the electronic apparatus, whereby the electronic apparatus starts to detect the peripheral device after receiving the delayed voltage signal.

2. The system of claim 1, wherein the voltage signal is a low voltage.

3. The system of claim 1, wherein the predetermined delay time is set as 0.82 seconds.

4. The system of claim 1, wherein the electronic apparatus is a notebook.

5. The system of claim 1, wherein the peripheral device is a printer.

6. A method for detecting a peripheral device being installed onto an electronic apparatus, the method comprising the steps of:
generating a voltage signal while the peripheral device is installed onto the electronic device;
receiving the voltage signal and, after a predetermined delay time, outputting a delayed voltage signal; and
receiving the delayed voltage signal and starting to detect the peripheral device.

7. The method of claim 6, wherein the voltage signal is a low voltage.

8. The method of claim 6, wherein the predetermined delay time is set as 0.82 seconds.

9. The method of claim 6, wherein the electronic apparatus is a notebook.

10. The method of claim 6, wherein the peripheral device is a printer.
